(19) United States
(12) Patent Application Publication
(10) Pub. No.: US 2005/0155663 A1
(43) Pub. Date: Jul. 21, 2005

(54) Thermally insulated pipeline

(76) Inventors: Jacques Dhellemmes, Versailles (FR); Pierre Michalski, Le Havre (FR)

Correspondence Address: YOUNG & THOMPSON, 745 SOUTH 23RD STREET, 2ND FLOOR, ARLINGTON, VA, 22202, US

(21) Appl. No.: 11/028,681

(22) Filed: Jan. 5, 2005

(30) Foreign Application Priority Data
Jan. 20, 2004 (FR) 04 00509

(51) Int. Cl. F16L 9/18

(52) U.S. Cl. 138/149; 138/148; 138/113

(57) ABSTRACT

A thermally insulated pipeline (T) includes from the inside to the outside:
a first sealed pipe (1),
a first thermal insulation layer (2),
a second sealed pipe (3),
a second thermal insulation layer (4),
a ballast (5), and
a sealed, impact-resistant protective casing (6).

The present invention relates to a thermally insulated pipeline intended particularly for the transportation, particularly the sub-sea transportation, of liquefied natural gas, to the use thereof and to a sea terminal comprising such a pipeline.

It is known practice to use stainless steel or nickel alloy pipelines for the surface transportation of liquefied gas between a methane tanker alongside a quay and a land-based storage tank. When these pipelines are put into service, cooling of the pipelines from ambient temperature to a very low temperature, for example −162° C. in the case of liquid methane at normal pressure, is accompanied by retraction of the materials constituting the pipeline. Mechanisms for compensating thermal retraction, in the form of loops, that is to say a pipe portion with a U-shaped lateral deviation, or in the form of compensators, that is to say a pipe portion which is corrugated in the manner of a bellows, are provided to prevent the pipelines from being damaged as a result of violent retraction.

Furthermore, the pipeline must necessarily comprise thermal insulation to prevent heating of the liquefied gas and thus limit its vaporization.

French Patent Application FR-A 2 748 545 discloses a thermally insulated pipeline for the transportation of liquefied natural gas. This pipeline comprises two coaxial tubes, a thermal insulator filling the tubular space contained between these tubes under controlled industrial vacuum, and also an outer concrete coating acting as ballast. The external tube consists of steel while the internal tube is made of Invar.

In conventional ballasted pipelines, if the outer ballast is caused to break, the piping is locally less dense than the water and is lifted off the bottom. Once initiated, this phenomenon is propagated spontaneously along the pipeline, which then yields or rises to the surface.

Moreover, French Patent Application FR-A-2 746 891 discloses a thermally insulated pipeline for the transportation of petroleum products. This pipeline comprises two coaxial tubes and a thermal insulator partially filling the tubular space contained between these two tubes under controlled industrial vacuum.

The aim of the invention is to propose a novel thermally insulated pipeline which exhibits numerous qualities. In particular, the aim of the invention is to provide a pipeline which offers a high level of thermal insulation and of operational safety.

To this end, the subject of the invention is a thermally insulated pipeline comprising from the inside to the outside:
a first sealed pipe,
a first thermal insulation layer,
a second sealed pipe,
a second thermal insulation layer made of insulating material, and
a ballast made of material with a density above that of sea water,
   characterized in that said first thermal insulation layer is made of insulating material, said pipeline additionally comprising a sealed, impact-resistant protective casing outside said ballast.

The double insulation layer makes it possible to minimize the amplitude of the thermal cycles to which the second pipe is subjected while at the same time retaining a second insulation capable of thermally insulating the concrete ballast and the steel casing from any invasion of the first insulation by the liquid.

By virtue of the superposition of the two pipes and of the protective casing, the present invention provides the installation with increased safety, both for this application and for other similar industrial applications.

Even in the event of the ballast fracturing, the ballast is held in place by the casing and the apparent weight of the pipeline remains unchanged as a result, which prevents the pipeline from rising or from breaking.

Preferably, at least one element from the group consisting of the first pipe, the second pipe and the protective casing has mechanical characteristics such that:
Re>E.α.ΔT
where E is the modulus of elasticity of the constituent material,
α is the coefficient of thermal expansion of the constituent material,
ΔT is the difference between the service temperature of said element and the ambient temperature,
and Re is the yield strength of the material at the service temperature of said element.

These characteristics make it possible, with respect to the corresponding element, to dispense, where appropriate, with a system for compensating thermal contraction. Thus, in the case of liquid gas transportation, as in the case of other similar industrial applications, the present invention proposes a particularly simple method for accommodating thermal expansion.

Advantageously, the two pipes exhibit these characteristics.

Advantageously, at least one of said sealed pipes consists of an alloy with a high nickel content. These alloys, such as Invar, for example, make it possible to obtain the mechanical characteristics above.

According to one embodiment, the second sealed pipe is made of a polymer resin-based composite. The use of such a material to produce the second sealed pipe gives rise to a significant reduction in the manufacturing costs for the pipeline. Furthermore, the composites may also be selected so that they exhibit the mechanical characteristics above.

Advantageously, the two pipes and the external casing meet this criterion, which makes it possible to produce a pipeline which may possibly not have any system for compensating thermal contraction.

According to another specific embodiment, at least one of said pipes is provided with at least one system for compensating thermal contraction. Such a system allows improved take-up of the thermal effects.

Preferably, said system for compensating thermal contraction takes the form of a sleeve comprising at least one radial corrugation.

As a preference, at least one element from the group consisting of the first pipe, the second pipe and the protective casing is anchored at its ends to fixed abutments which take up the thermal stresses to which said element is subjected.

Advantageously, the ballast consists of a material capable of being cast in a liquid, pulverulent or granular form into the cylindrical volume contained between the second insulation layer and the protective casing. Preferably, said ballast comprises concrete inside the protective casing. This is because concrete is easy to cast, the casing acting as a mould. Furthermore, the concrete is then protected from the external environment by the steel casing, providing the assembly with good impact resistance and with perfect sealing.

The very composition of the pipe and the choice of the nature of the materials contribute to the ready implementation and exploitation of the invention. Specifically, the use of concrete makes it possible to overcome the assembly constraints encountered in conventional production techniques. Casting the concrete into a steel casing also makes it possible to optimally benefit from the good mechanical resilience of steel and thereby reduce the impact sensitivity of the pipeline while at the same time allowing visual inspection of the casing in order to detect any points of corrosion.

Even more preferably, a protective film is arranged between the concrete ballast and said secondary thermal insulation layer. The protective film has the task of preventing concrete laitance from invading the secondary insulation layer during casting.

Advantageously, said ballast comprises at least one hollow duct provided in the latter, which can be used for ventilation or for draining. Preferably, the hollow duct is arranged in the longitudinal direction and over the whole length of said pipeline. The hollow duct additionally makes it possible to discharge water exuded from the concrete during drying or to detect any intrusion of sea water. Where appropriate, it also makes it possible to circulate inert gas.

Preferably, at least one of the thermal insulation layers is made of a material having a thermal conductivity of below 20.10⁻³W.m⁻¹.K⁻¹ at ambient temperature, preferably below 16.10⁻³W.m⁻¹.K⁻¹ at −160° C. Aerogels generally satisfy this criterion.

With such insulation, the controlled industrial vacuum is no longer mandatory to ensure satisfactory thermal insulation, which prevents having to provide depressurization apparatus and having to specifically dimension the pipelines so that the controlled industrial vacuum can be installed. The invention therefore makes it possible to dispense with the controlled industrial vacuum mentioned above by using high-performance insulating materials, and thus simplifies the implementation and exploitation of the pipeline.

Advantageously, at least one of the thermal insulation layers is made of aerogel-type nanoporous material. An aerogel is a low-density solid material having a structure which is extremely fine and highly porous (up to 90%). For example, it may be manufactured from a number of materials comprising silica, alumina, hafnium carbide and also varieties of polymers. Its nanoscale structure gives it unique thermal insulator properties, given that the average distance traveled by the gas molecules and therefore the transport of energy and mass within it are reduced. It offers a thermal conductivity two to four times below that of other insulators of the solid or insulating foam type, for example.

According to one specific embodiment of the invention, at least one of the thermal insulation layers is in textile form. According to another specific embodiment of the invention, at least one of the thermal insulation layers is present in a pulverulent or granular form allowing it to be cast into the volume intended to receive it. For example, a thermal insulation layer such as this may be in the form of beads. The use of pulverulent or granular materials makes it possible to facilitate assembly of the pipeline, particularly by imposing less precise tolerances than in the prior production techniques. Specifically, these materials allow positioning errors between the pipes without causing discontinuity of the insulation.

More preferably, this insulation layer or these insulation layers in a pulverulent or granular form comprises or comprise at least one section closed off at its or their two longitudinal ends by blocking devices made of insulating material. These blocking devices may be gas-permeable. These blocking devices may also be traversed longitudinally by holes which are, where appropriate, plugged by gas-permeable filters, for example of the glass fabric type. The gas permeability makes it possible to perform nitrogen flushing, for example.

Advantageously, said thermal insulation layer in a pulverulent or granular form comprises at least one spacer bar made of insulating material, which is arranged parallel to said pipeline and has a thickness substantially equal to that of said thermal insulation layer. The spacer bars may be gas-permeable.

According to a specific embodiment of the invention, a device for detecting leaks, which may be an optical fiber, for example, is arranged in the longitudinal direction over the whole length of said pipeline, between the first pipe and the protective casing.

Advantageously, the pipeline is formed by prefabricated sections which can be connected end to end. In the region of these connections, the thermal insulation layers are advantageously in textile form. The casing and the sealed pipes may be connected with the aid of added parts or directly by a weld bead.

Even more advantageously, the sections have at least one stepped end, the constituent elements of said sections having a relatively decreasing longitudinal extension in the outwardly radial direction. This configuration of the sections forms reliefs which facilitate their assembly.

The invention also provides a use of the pipeline herein above for the transportation of a low-temperature fluid. The low-temperature fluid may be liquefied gas, for example.

According to a particular embodiment, an inerting gas is circulated through at least one of the thermal insulation layers. However, the circulation of inert gas is proposed in a preferred embodiment in order to prevent the formation of an explosive mixture caused by gas resulting from a possible leak being brought into contact with the air contained in the thermal insulation. The inert gas can be circulated at a pressure above atmospheric pressure.

Another subject of the invention is a sea terminal for the transportation of liquefied gas, characterized in that it comprises a loading and unloading station connected to a land installation by at least one pipeline according to the invention, it being possible for the ends of said pipeline to be anchored to fixed abutments. The land installation is a liquefied gas storage depot, for example.

The invention will be better understood, and other aims, details, characteristics and advantages thereof will become more clearly apparent, in the course of the detailed explanatory description which will follow, of a number of embodiments of the invention given by way of purely illustrative and non-limiting example, with reference to the appended schematic drawings.

In these drawings:

FIG. 1 is a side view of the end of a section of section according to a first embodiment of the present invention;

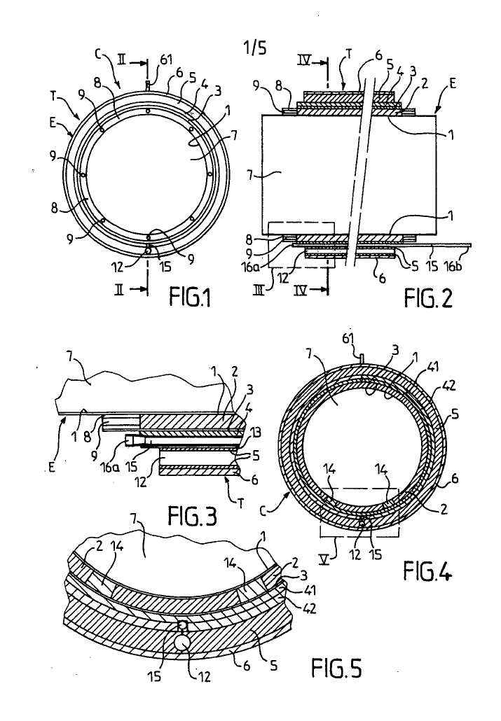

FIG. 2 is a partial view in longitudinal section of the pipeline section according to FIG. 1 along the axis II-II;

FIG. 3 is an enlarged view of a region of FIG. 2 denoted by III;

FIG. 4 is a cross section of the pipeline section of FIG. 2 along line IV-IV;

FIG. 5 is an enlarged view of a region of FIG. 4 denoted by V;

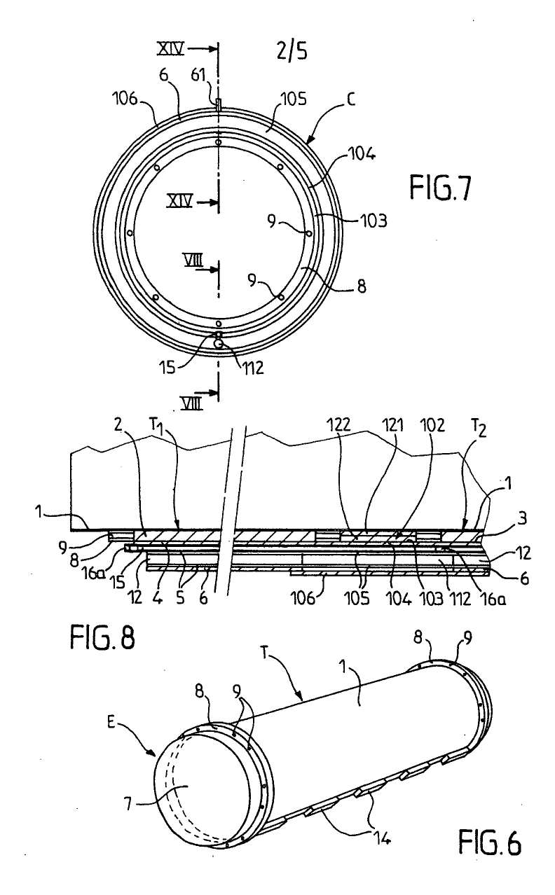

FIG. 6 is a perspective view of an inner pipe of the pipeline section of FIG. 1, exhibiting the blocking devices and the spacer bars;

FIG. 7 is a cross section of the pipeline according to the first embodiment in the region of a connection between two pipeline sections;

FIG. 8 is an enlarged partial view of the connection of FIG. 7 in longitudinal section along line VIII-VIII;

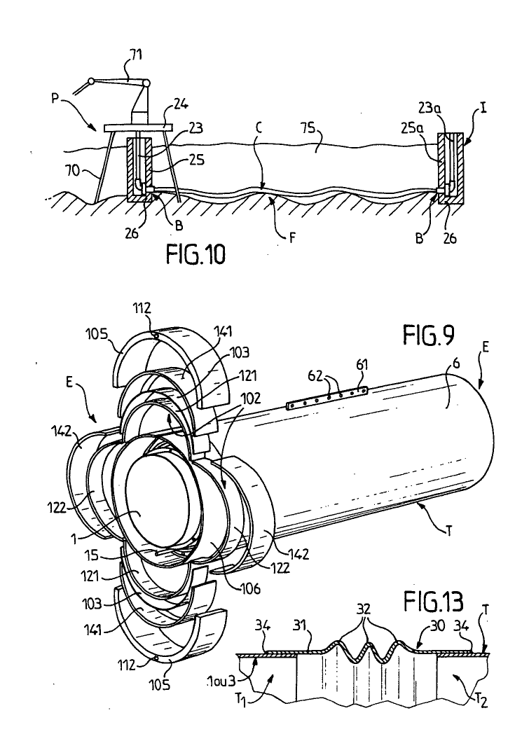

FIG. 9 is an exploded perspective view of the various added elements for constituting a connection at the end of a pipeline section;

FIG. 10 is a diagram representing the configuration of a sea terminal for the transportation of liquefied gas, comprising the pipeline according to the first embodiment;

FIG. 11 is a part-sectional longitudinal view of one end of the pipeline of FIG. 10 anchored in a fixed abutment;

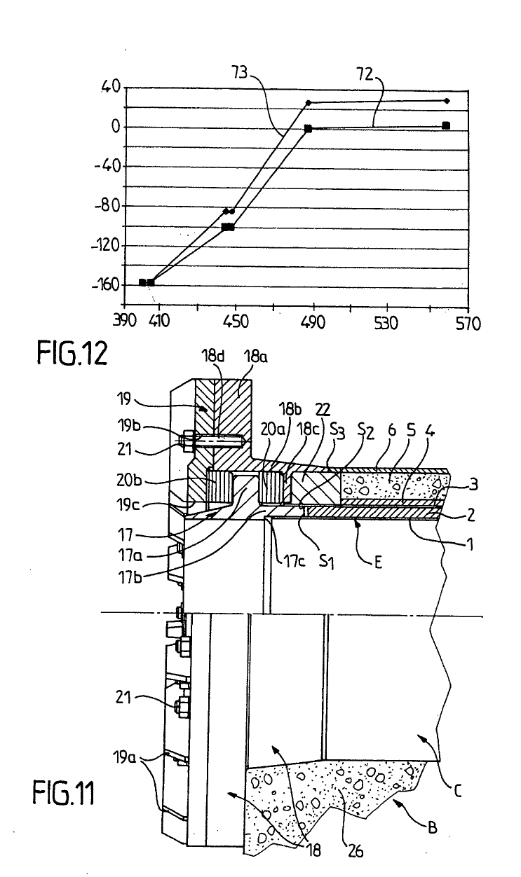

FIG. 12 is a diagram representing a temperature profile at different points on the pipeline of FIG. 10;

FIG. 13 is a sectional partial view of a system for compensating thermal contraction in a pipeline according to a second embodiment of the invention, and

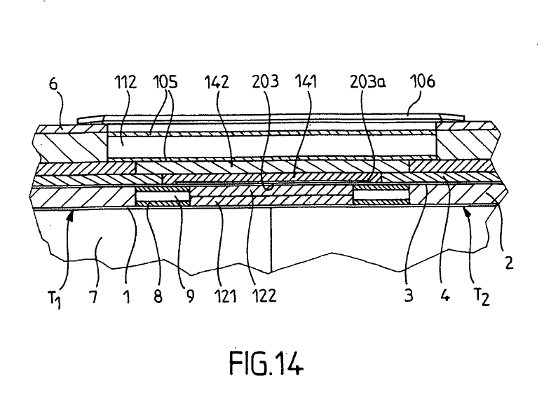

FIG. 14 is an enlarged partial view of another embodiment of the connection of FIG. 7 in longitudinal section along line XIV-XIV.

With reference to FIGS. 1 to 6, a section T of the pipeline C according to a first embodiment will now be described. The section T has a multilayer structure with, from the inside toward the outside, a first sealed pipe 1, a first insulation layer called primary insulation layer 2, a second sealed pipe 3, a second insulation layer called secondary insulation layer 4, a protective film 13, a concrete coating 5 and a protective casing 6.

FIGS. 1, 2 and 3 illustrate the configuration of the ends E of the section T.

According to FIG. 2, a section T comprises a first pipe 1 of cylindrical shape and of circular cross section. This first pipe 1 is sealed and consists of a material with a low coefficient of expansion. It may, for example, consist of Invar, available especially from Imphy Alloys.

The first pipe 1 allows the transported fluid, which is preferably liquefied gas, to pass through its bore 7. It constitutes a first sealing barrier with respect to the transported fluid.

A primary insulation layer 2 surrounds the first pipe 1 over its external surface. This primary insulation layer 2 is less extended longitudinally than the primary pipe 1. It consists of a material with low thermal conductivity, that is to say below 20.10⁻³W.m⁻¹.K⁻¹ at ambient temperature. This material may, for example, be an aerogel whose thermal conductivity is below 16.10⁻³W.m⁻¹ .K⁻¹ at −160° C.

Preferably, the aerogel used in this insulation layer 2 is in the form of beads. Suitable aerogel beads are available especially from Cabot Corporation.

Blocking devices 8 of toric shape occupy the end of the primary insulation layer 2, at each end E of the sections T.

As can be seen in FIGS. 4, 5 and 6, the primary insulation layer 2 comprises, longitudinally, pairs of spacer bars 14 spaced in the azimuthal direction. These bars 14, according to FIGS. 4 and 5, are spaced by an angle substantially equal to 90° and are situated on either side of the lower generating line of the primary insulation layer 2. According to FIG. 6, each section T has five pairs of spacer bars 14. The blocking devices 8 and the spacer bars 14 preferably consist of a gas-permeable material whose thermal conductivity is close to that of the aerogel of the layer 2. This material may, for example, be a phenolic foam or a polyurethane foam.

Consequently, no thermal bridges are formed between the first pipe 1 and the other elements of the section T.

As a variant, the spacer bars 14 may be spaced by a different angle and may vary in number, in size, in shape and in arrangement in the azimuthal plane. It is also possible to envision these spacer bars 14 taking the form of a single longitudinal alignment of strips along the lower generating line of the primary insulation layer 2.

The primary insulation layer 2 serves to limit the supply of heat from the external environment toward the first pipe 1.

The blocking devices 8 make it possible to confine the aerogel beads within the primary insulation layer 2. A first blocking device 8 is placed at one of the ends of the primary insulation layer 2 so as to form a sealed receptacle. A second blocking device 8 is placed at the other end of the primary insulation layer 2 after the latter has been filled with aerogel beads.

Finally, the first pipe 1 is supported by the second pipe 3 by means of at least one spacer bar present in the primary insulation layer 2, that is to say the pairs of spacer bars 14 in the example represented. Specifically, said spacer bars 14 make it possible to transmit the self-weight of the first pipe 1 to the second pipe 3 without damaging the primary insulation layer 2.

The blocking devices 8 are preferably gas-permeable, which makes it possible to circulate an inerting gas, which may be nitrogen, within the primary insulation layer 2, preventing the formation of an explosive mixture due to the transported fluid being brought into contact with air in the event of a loss of sealing of the first pipe 1. The primary insulation layer 2 can be flushed with inerting gas by injecting nitrogen (N₂) at one of the ends of the primary insulation layer 2. The inert gas can be circulated by applying pressure at one of the ends of the primary insulation layer 2 and drawing off at the other. Inerting the primary insulation layer 2 can make it possible to monitor the gas present in this layer 2 and consequently detect any leakage.

According to FIG. 1, each blocking device 8 is traversed longitudinally by eight holes 9. These holes 9 are closed off by a gas-permeable material. However, if the blocking devices 8 are gas-permeable, the holes 9 are then optional. The holes 9, the number and arrangement of which may vary in the blocking devices 8 and which are closed off by a gas-permeable material, such as bonded glass fabric, are used to facilitate the circulation of the inerting gas while not allowing the primary insulation layer 2, that is to say the aerogel beads, to escape.

A second pipe 3, also sealed and of circular cross section, is arranged around the primary insulation layer 2, coaxially with the first pipe 1. In this embodiment, the second pipe 3 consists of the same material and has the same thickness as the first pipe 1. It differs from the first pipe 1 in that it is less extended longitudinally than the first pipe 1 at each end E. It can also be observed that the second pipe 3 has the same length as the underlying primary insulation layer 2. This implies that a corresponding relief is provided between the first pipe 1 and the second pipe 3.

This second pipe 3 also constitutes a sealing barrier with respect to the transported fluid in the event of invasion of the primary insulation layer 2 by gas following a leak of the first pipe 1. The second pipe 3 also plays a role in reducing the contraction of the pipeline C by comparison with conventional pipelines. Specifically, since it consists of a material with a low coefficient of expansion such as Invar, like the first pipe 1, it expands far less than any other metal and, like the first pipe 1, avoids the need to install means for compensating expansion stresses, for example loop-form or bellows-type compensators.

A secondary insulation layer 4 surrounds the second pipe 3. This secondary insulation layer 4 consists of two superposed layers, the internal layer 41 and the external layer 42. They consist of a material with low thermal conductivity which may, for example, be a nanoporous material made of aerogel, preferably in textile form, with a thermal conductivity of 12.10⁻³W.m⁻¹.K⁻¹ at −160° C. This material will also advantageously be gas-l permeable. A suitable aerogel fabric is available especially from Aspen Aerogels. Each internal 41 or external 42 layer consists of two half-shells in a similar manner to the layers 141 and 142 represented in FIG. 9. According to a specific example, the thickness of the internal insulation layer 41 is 19.2 mm and the thickness of the external layer 42 is 22.4 mm. The half-shells forming the external layer 42 are dimensioned, particularly in terms of thickness, to accommodate a hollow sheath 15 of circular cross section which passes longitudinally through the section T over its whole length, at the lower junction of the two half-shells constituting the external layer 42. This sheath 15 is intended to house an optical fiber or any other system for detecting and locating a leak. The sheath 15 has a flared end 16a in the form of a bell socket, which connects to the other end 16b of the sheath 15 of an adjacent section T. The secondary insulation layer 4 is less extended longitudinally than the second pipe 3. This implies that an additional relief is provided between the secondary insulation layer 4 and the second pipe 3. The secondary insulation layer 4 may consist of a different number of layers, consist of another material or not house, within its thickness, a sheath 15 for an optical fiber.

The secondary insulation layer 4 is used to limit the supply of heat from the external environment toward the second pipe 3. It is also used to thermally insulate the outside of the second pipe 3 and prevents excessive cooling of the outer protective coating 6 in the event of invasion of the primary insulation layer 2 by liquefied gas subsequent to a leak of the first pipe 1. The secondary insulation layer 4 is preferably gas-permeable. This implies that it is also possible to circulate an inerting gas, which may be nitrogen, within this insulation layer 4 with a similar aim to that previously described for the insulation layer 2.

The optical fiber (not represented), preferably placed in the sheath 15, forms part of a leak-detecting device. This device for detecting and locating a leak is a linear fiber-optic type temperature sensor (DTS: distributed temperature sensor) used to detect and locate any abnormal cold point within the external layer 42 due to any leak of liquefied gas. The optical fiber is placed in the sheath 15 once the pipeline C is assembled. It may be pulled along the pipeline using an aramid fiber, for example, or may be pushed along using compressed air. It may be replaced in the same way as it was installed, without intervention on the pipeline C, by pulling it, for example, using the same aramid fiber, along the pipeline. It is also possible to envision installing such a leak-locating device when joining the sections. It is preferable to position to optical fiber in the external layer 42 of the secondary insulation layer 4 for a number of reasons. First of all, at this location, in the event of any leak, the optical fiber detects variations of significant amplitudes and it is not subjected to too large thermal cycles, which could harm its operation. Finally, at this position, the amplitude of the signal of the optical fiber remains acceptable in spite of the low temperature.

A protective casing 6, also of circular cross section, is arranged coaxially around the secondary insulation layer 4, at a distance therefrom. The protective casing 6 is provided, over its upper generating line, with lifting devices 61. According to FIG. 9, the lifting devices 61 are in the form of a bar whose length is less than that of the section T, this bar being arranged in the longitudinal direction of the section T halfway between the ends E. The lifting devices 61 are traversed transversally by orifices 62. The protective casing 6 is made of steel provided with an excess thickness and with an anti-corrosion coating so as to limit corrosion by sea water. The excess thickness also makes it possible to protect the pipeline C from any external impact.

The lifting devices 61, for their part, allow the pipeline C to be raised and manipulated by way of their orifices 62. The protective casing 6 is less extended longitudinally than the secondary insulation layer 4, this creating an additional relief between the outside of the pipeline C and the secondary insulation layer 4.

A protective film 13 can be placed around the secondary insulation layer 4 to prevent it being invaded by the concrete.

A concrete coating 5 is cast and fills the tubular space contained between the central part of the pipeline (pipe 1, insulation layer 2, pipe 3, insulation layer 4 and any protective film 13) and the protective casing 6. A hollow duct 12 is arranged in the longitudinal direction and over the whole length of the section T. This hollow duct 12 may have a circular cross section.

The concrete coating 5 makes it possible to give the empty pipe a total density which is above that of sea water so that the pipeline C rests naturally on the bottom of the sea in the empty state (density of the loaded concrete around 3). The apparent mass of the immersed pipe must be greater than 10 kg per meter. This limits the movements experienced by the pipeline C and thus limits damage thereto. The hollow duct 12 makes it possible not only to purge the infiltration of sea water in the concrete coating 5 following any leak of the protective casing 6 which surrounds it, but also to discharge the water resulting from the drying of the cast concrete and, where appropriate, also to circulate an inert gas. The function of the hollow duct 12 is to drain or ventilate the pipeline.

The protective film 13 optionally placed around the secondary installation layer 4 has the function of protecting the latter from invasion by the laitance of the concrete 5 when it is cast into the protective casing 6. It must also protect the secondary insulation layer 4 from the abrasive effect of the concrete coating 5 and from any friction between the secondary insulation layer 4 and the concrete coating 5 due to differences in thermal contraction during the passage of liquid gas.

The pipeline C is formed of sections T connected end to end at the ends E. The sections T measure four meters in length, for example. They are connected end to end to form a pipeline C of the desired length, for example of about 5000 m. The length of the sections T and the number thereof may obviously vary depending on the application. As has been described above, the various elements making up a section T have, relative to one another, a longitudinal extension reducing in the outwardly radial direction. This stepped structure of the ends E of the section T makes it possible to facilitate the operations of welding together the various sections T. Specifically, this structure creates reliefs which facilitate access to the deepest structures, such as to the first pipe 1, for example. The relief thus created will also make it possible to supply added parts for the welding operations and to position layers of insulating materials in the region of the connections.

The structure of a connection between two sections T is represented by FIGS. 7, 8 and 9.

The first pipes 1 of the two adjacent sections T1 and T2 are welded end to end by a weld bead

Then two primary insulation layers 102 are arranged around the weld of the first pipes 1: the internal primary insulation layer 121 and external primary insulation layer 122. The internal 121 and external 122 primary insulation layers are each formed by a pair of half-shells, represented in FIG. 9, consisting of insulating material, for example in textile form which may be aerogel. The junction planes of the two pairs of half shells are perpendicular to one another.

Next, the second pipes 3 of the two sections T1 and T2 are welded to one another with the aid of added parts which are, according to the embodiment represented, in the form of half-shells 103, but which may also be in the form of a split ring. The two half-shells 103 made of Invar are welded in a sealed manner to the second pipes 3 by peripheral weld beads and to one another by longitudinal weld beads.

Then two secondary insulation layers 104 are arranged around the half-shells 103 which connect the second pipes 3: the internal secondary insulation layer 141 and external secondary insulation layer 142. The internal 141 and external 142 secondary insulation layers have the same composition as the internal 121 and external 122 primary insulation layers mentioned above. The external secondary insulation layer 142 allows the sheath 15 to pass through in the region of the lower joint of its two half-shells. Moreover, the sheath 15 of the optical fiber is slid into this joint after welding the half-shells 103 so as not to interfere with this weld. The use of pairs of preformed half-shells for the primary 102 and secondary 104 insulation layers makes it possible to simplify the operations of handling and installing the insulation. The use of pairs of half-shells of different colors further simplifies the laying thereof.

Then a pair of concrete half-shells 105 is arranged around the secondary insulation layers 104. Each half-shell 105 is traversed longitudinally by a hollow duct 112 over its upper generating line. The hollow duct 112 in the lower half-shell makes it possible to connect the hollow ducts 12 of the successive sections T1 and T2.

A protective film 13, which is not represented in FIG. 9, may optionally be added between the secondary insulation layers 104 and the concrete half-shells 105.

Finally, the protective coatings 6 of the two sections T1 and T2 are connected with the aid of an external added part which is, advantageously, in the form of a split ring 106 paired with the adjacent tube 6 of larger diameter. The split ring 106 is brought longitudinally along one of the sections until it is at the level of the connection so as to be welded to the ends of the protective coatings 6 of the adjacent sections T1 and T2 by two sealed peripheral weld beads.

### Specific Example of Dimensioning

The internal diameter of the first pipe 1 is 800 mm and its thickness is 3 mm. The inside diameter is justified by the first estimations of pressure drop. The thickness of the first pipe 1 was gaged to 3 mm as a function of the stagnation pressure of the pumps of a methane tanker, allowing for a stress equal to 66% of the yield strength.

The thickness of the primary insulation layer 2 is 40 mm. The second pipe 3 has an external diameter of 892 mm and it is less extended longitudinally than the first pipe 1, being 150 mm shorter at each end E.

The secondary layer 4, also having a thickness of 40 mm, is less extended longitudinally than the second pipe 3, being 100 mm shorter at each end E.

The protective casing 6 has a thickness of about 16 mm.

The concrete coating 5 has a thickness of about 55 mm and the hollow duct 12 has a diameter of about 40 mm.

A section T of 4000 mm, the length of the first pipe 1 is 4000 mm, that of the primary insulation layer 2 and of the second pipe 3 is 3700 mm, that of the secondary insulation layer 4, of the protective film 13 and of the protective casing 6 is 3500 mm, and that of the concrete coating is 3480 mm.

As illustrated in FIG. 10, a description will now be given of a sea terminal in which the pipeline C described above is used for conveying liquefied gas between a loading and unloading station P and a land installation I. The reference 75 denotes the sea level.

The loading and unloading station P refers to a fixed offshore installation. The loading and unloading station P comprises a moving arm 71, and a platform 24 which is supported by pillars 70 and which supports the moving arm 71. A fixed concrete tower 25 is constructed under the platform 24. The moving arm 71 carries a sleeve (not shown in FIG. 10) which can be connected to the loading/unloading lines of a methane tanker according to the prior art. The moving arm 71 is connected to a connection pipe 23 which extends between the platform 24 and the seabed F inside the fixed tower 25. In the bottom of the fixed tower 25, the connection pipe 23 is connected to the pipeline C by a fixed abutment part B embedded in the concrete 26.

The loading and unloading station P, via its swivelable moving arm 71 which is adapted to all gages of methane tankers, makes it possible to load the methane tanker (not shown) with liquid or to unload liquid therefrom.

The land installation I likewise comprises a connection pipe 23a, which is connected to liquefied gas storage tanks (not shown) and which extends as far as the seabed F inside a fixed tower 25a. In the bottom of the fixed tower 25a, the connection pipe 23a is likewise connected to the pipeline C by a fixed abutment part B embedded in the concrete 26. The non-immersed connection pipes 23 and 23a can be designed according to the prior art, for example in the form of stainless steel pipes lined with suitable insulation and provided with compensation systems.

The ends of the pipeline C are anchored to fixed abutment parts B at a loading or unloading station P and at a land installation I.

The pipeline C which connects the loading and unloading station P and the land installation I rests on the seabed F. It allows liquefied gas to be transferred between the loading or unloading station P and the land installation I over a long distance, for example 5 km, which allows the station P to be placed at a long distance from the shore. Two pipelines C dimensioned according to the example above can transport the liquefied gas at a flow rate of 6000 m³/h, which allows a 144000 m³ methane tanker cargo to be transferred in twelve hours.

A pipeline C according to the invention may also be provided between the loading and unloading station P and the land installation I to convey gas in vapor form. It is functionally different from but physically identical to the two aforementioned pipelines, which transport liquefied gas. This pipeline is used, during unloading of the methane tanker, to convey toward the methane tanker the volume of gas in vapor form necessary to replace the volume of the liquid gas that is being unloaded.

The laying of the pipeline C comprises the steps of preassembling the sections T on land and then of assembling at sea the preassembled sections T and of connecting the pipeline C to the fixed abutment parts B. In order to minimize the number of assembly operations at sea, preassembly of the 4-meter sections T in units of 40 to 60 meters, for example, may be carried out. It may then be envisiond to assemble the preassembled 40 to 60-meter sections T from an S-lay barge. The barge must be equipped with a stinger so as to support the portion of pipeline C suspended between the seabed F and the barge. Installation from land may also be envisioned.

The connection of the pipeline C to the fixed abutment parts B is represented in FIG. 11. Each fixed abutment part B is composed of various elements, namely: an internal clamp 17, an external clamp 18 and a cover 19.

The internal clamp 17 comprises a pipe 17b whose internal surface has a shoulder 17c and whose external surface has a radially projecting peripheral collar 17a. The outside diameter decreases from the collar 17a toward the end facing the cover 19.

The external clamp 18 comprises three parts: a pipe 18b, a radially external peripheral collar 18a at its end facing the cover 19, and a radially internal annular collar 18c between the two ends of the pipe 18b. The inside diameter of the annular collar 18c corresponds substantially to the outside diameter of that portion of the pipe 17b situated between the collar 17a and the end facing the pipeline C. The external clamp 18 comprises a series of threaded pins 18d arranged on that face of the collar 18a facing the cover 19. The external diameter of the external clamp 18 decreases slightly in that part contained between the collar 18a and the end S3 connected to the protective casing 6 of the pipeline C.

The cover 19 has roughly the shape of a disc traversed longitudinally by orifices 19b arranged over a circle which is concentric to the axis of revolution of the cover. The cover 19 also has a central opening 19c, the diameter of which corresponds substantially to the external diameter of the pipe 17b. The cover 19 also has ribs 19a projecting from its face remote from the external clamp 18, these ribs not only promoting heat exchange but also stiffening the cover 19.

Finally, concrete 26 surrounds the external surface of the pipe 18b and of the end E of the pipeline C which is connected to it.

A description will now be given of the way in which the pipeline C is assembled to the fixed abutment part B.

The end E of the pipeline C is assembled to the fixed abutment part B preferably outside the water, and then, after fitting a stopper, the assembly is immersed so that it can be fixed in the concrete. First of all, the end E of the pipeline C is pushed into the bore of the pipe 17b of the internal clamp 17 without reaching the shoulder 17c. The end of the first pipe 1 is welded to the internal surface of the pipe 17b between the end S1 and the shoulder 17c. The second pipe 3 for its part is welded to the external surface of the pipe 17b between the end S2 and the radially internal collar 18c of the external clamp 18, the thickness of the pipe 17b over this portion corresponding exactly to the thickness contained between the first pipe 1 and the second pipe 3.

An insulating element 22 is placed in the space defined between the collar 18c and the end of the secondary insulation layer 4 and of the concrete coating 5. The insulating element 22 enables the insulation of the secondary insulation layer 4 and of the concrete coating 5 to be extended within the external clamp 18.

The internal clamp 17 is positioned longitudinally with respect to the external clamp 18 by inserting a first positioning wedge 20a between the radially internal collar 18c and the radially external collar 17a of the internal clamp 17. A weld is made at the end S3 securing the protective casing 6 and the external clamp 18. A second positioning wedge 20b is placed against the collar 17a remote from the first positioning wedge 20a.

The cover 19 is then placed against the second positioning wedge 20b and the radially external collar 18a by engaging the pins 18d through the orifices 19b. Then the cover 19 is kept in bearing contact by means of nuts 21 screwed onto the pins 18d. The cover 19, bearing against the wedge 20b, immobilizes the internal clamp 17 in the external clamp 18.

It can also be envisioned to mount the fixed abutment B under water.

Thus, as a result of this anchoring of the two ends E of the pipeline C in the fixed abutment parts B, the pipeline C is able to be placed under tension between the loading and unloading stations P and the land installation I without providing devices for compensating thermal retraction. The result is a reduction in pressure drops and an improvement in the transported flow rate. The fixed abutment parts B are designed and fixed in such a way as to resist thermal contractions due to the transportation of the liquefied gas. The fixed abutments B thus constitute elements for taking up thermal loads. The tensile forces due to the chilling of the pipes 1 and 3 and, where appropriate, to the cooling of the outer protective casing 6—the temperature of which follows that of the surrounding environment—are partially compensated during the unloading operation—by the bottom effect which corresponds to the pressure drop in the pipe 1 applied to the flow cross section. However, the stresses due to the bottom effect are low by comparison with those due to the retraction of the materials.

The dimensions described in the example above are, of course, neither imperative nor restrictive and must be adapted each time to the constraints imposed by the intended application.

A method will now be given for dimensioning tubes of circular cross section which are subjected to an internal or external pressure, these tubes being, in the case of the pipeline C, the sealed tubes 1 and 3 and the protective casing 6.

The internal pressure (Pint) and external pressure (Pext) to which a tube is subjected are known. It is then possible to calculate a minimum thickness (eMin) using the formula below:

$$e Min = \frac{Peff \times f}{2 A \times Rpe} + C$$

in which:

$$\begin{matrix}Peff = \vert P int - P ext ) \vert \\ Rpe = \frac{Re}{S}\end{matrix}$$

with d: inside diameter of the tube (mm)
Peff: differential pressure (MPa)
Rpe: practical tensile strength of the
   material (MPa)
Re: yield strength of the material (MPa)
S: safety factor >1
A: assembly coefficient depending on the tube-forming method
C: corrosion allowance (mm)

Example: Table 1, appended, gives an example of the dimensioning of a sub-sea pipeline C at a depth of 35 m. The internal dimensioning pressure used is a pressure 1.5 times stagnation pressure of the pumps of the methane tanker delivering the liquid, that is to say 15 bar. This pressure of 15 bar is intended to be withstood by the first pipe 1 and, where appropriate, by the second pipe 3, which must resist this pressure if the first pipe 1 yields. The protective casing 6 must resist double the immersion pressure, that is to say about 7 bar. The internal pressure of the protective casing 6 under water is atmospheric pressure, because the space situated between the pipe 3 and the casing 6 communicates with the atmosphere through the abutment part B. Its external pressure, due to immersion under 30 m of water and 5 m of tidal range, is about 3.5 bar.

The minimum thicknesses eMin calculated to resist the internal pressure in each pipe are 1.49 mm for the first pipe 1 and 1.75 mm for the second pipe 3. The minimum thickness anticipated for the protective casing 6 is 2.63 mm when the pipeline C is immersed at 30 m under water.

However, in practice and for safety reasons, in the numerical example above, thicknesses of 3 mm for the first pipe 1 and the second pipe 3 and of 16 mm for the protective casing 6 have been chosen.

The temperature profile within the thickness of the pipeline C according to the numerical example above, used for the sub-sea transportation of liquid methane, is represented in FIG. 12. This diagram represents the service temperature (in 0°C.) as a function of distance from the centre of the pipeline C (in mm). The service temperature is the temperature within the various elements of the pipeline when transporting liquid gas. The curve 72 represents the scenario in which the temperature outside the pipeline C is 4° C. The curve 73 represents the scenario in which the temperature outside the pipeline C is 30° C.

The two curves have the same general course. The temperature increases from the centre of the pipeline C toward the outside. Each curve is composed of six points. The first point of each curve, at a temperature of about −160° C., represents the temperature inside the first pipe 1, the second point represents the temperature outside the first pipe 1, the third point represents the temperature inside the second pipe 3, the fourth point represents the temperature outside the second pipe 3, the fifth point represents the temperature outside the concrete coating 5, and the sixth point represents the temperature outside the protective casing 6, that is to say the temperature of the surrounding sea environment.

Between the second and the third point of the curves 72 and 73, the temperature gradient is steep. That signifies that the primary insulation layer 2 effectively performs its function as thermal insulator.

At the third and fourth points of the curves 72 and 73, the temperature is about −100° C. for the first curve 72 and −85° C. for the second curve 73. It can be seen that the temperatures in the region of the second pipe 3 are still very cold.

Between the fourth and the fifth point of the curves 72 and 73, it can be seen that the gradient is even steeper than at the primary insulation layer 2. This signifies that the secondary insulation layer 4 is slightly more effective than the primary insulation layer 2.

Finally, at the fifth and sixth points of the curves 72 and 73, the temperature gradient is virtually zero. That signifies that the concrete coating 5 and the casing 6 play no substantial role in the insulation of the pipeline C.

A description will now be given of a second embodiment of the pipeline C, in which the thermal retraction effects on the first pipe 1 or on the second pipe 3 during transportation of liquefied gas are taken up by compensation mechanisms along the pipeline C.

The structure of the sections T according to the second embodiment is identical to that of the sections T according to the first embodiment. The structure of the sections T according to the second embodiment is therefore illustrated by FIGS. 1 to 5.

The pipeline C according to the second embodiment comprises connections between sections which differ from the connections of the first embodiment, because they comprise systems 30 for compensating thermal contraction interconnecting the first pipes 1 and/or the second pipes 3.

A system 30 for compensating thermal contraction is partially represented in FIG. 13. This is a tubular sleeve 31 which has, at both of its ends, an internal diameter corresponding to the external diameter of the first pipes 1 or of the second pipes 3 which are to be connected. This latter characteristic makes it possible for the sleeve 31 to receive the ends of the first pipes 1 or of the second pipes 3. The ends 34 of the sleeve 31 are thus welded by a sealed peripheral weld bead to the surface of the first pipes 1 or of the second pipes 3. In FIG. 13, the sleeve 31 connects two first pipes 1 or second pipes 3 belonging to two adjacent sections T1 and T2.

The sleeve 31 consists of a material allowing tailored assembly with the adjacent pipes 3 by means of adhesive bonding or welding, for example. It has at least one peripheral radial corrugation 32 in the form of an accordion in its central position, that is to say three corrugations 32 in the example represented. During transportation of the liquefied gas, the structure formed by the corrugations 32 stretches out and bunches up in step with deformations of the corresponding pipe due to variations in temperature. The sleeve 31 thus constitutes an element for locally taking up thermal effects.

In the connections of the second embodiment, the systems 30 for compensating thermal contraction are arranged to straddle the second pipes 3 of two adjacent sections T1 and T2, that is to say in place of the added parts 103 of the first embodiment, and/or between the first pipes 1. The other elements making up the connection (primary 102 and secondary 104 insulation layers, concrete coating 105 and split ring 106 of the protective casing 6) are identical to those of the first embodiment.

The second embodiment of the pipeline C is advantageous in that it makes it possible for the first pipe 1 and/or the second pipe 3 to consist of a material which does not have a low coefficient of expansion by contrast with the first embodiment, for example stainless steel, various alloys, or composites. This results in an economic benefit. In this case, the compensation systems are used in pipes made of stainless steel or of another expandable material. Pipes not consisting of a material with a low coefficient of expansion exhibit intense longitudinal retraction upon chilling, which, in the absence of suitable compensation, could have the consequence of the anchorage being pulled away from the ends of the pipeline C or of the pipe being torn away itself if the anchoring were to resist these stresses.

However, in a pipe made of expandable material, connections according to FIGS. 7 to 9 can also be used in alternation with compensation systems 30. The structure of the connections without compensation systems 30 is then identical to that of the first embodiment, apart from the fact the pair of half-shells 103 for welding the second pipe 3 is made of a material which does not necessarily have low thermal expansion but which is compatible with the assembly method.

In the second embodiment, it is also possible to use Invar pipes 1 and 3. In this second embodiment, it is also possible to envision designing a pipeline C of which one of the pipes 1 or 3 is made of a material with a low coefficient of expansion and the other is not. A complete computation using finite elements makes it possible, case by case, to decide whether or not thermal effects need to be taken up locally.

The ends of the pipelines C according to the second embodiment may also be anchored by means of fixed abutments B to a loading and unloading station P and to a land installation I in an identical manner to the first embodiment, with reference to FIGS. 10 and 11.

A description will now be given of a third embodiment illustrated in FIG. 14.

In the above-described example giving dimensions, it was deemed necessary for the second pipe 3 to be capable of withstanding 1.5 times the stagnation pressure of the pumps. This requirement may appear to be too strict given that a clean fracture of the first pipe 1 is highly improbable, with only possible leaks or regions of porosity of the pipe 1 having to be envisioned in practice.

It is thus possible to dimension the second pipe 3 more modestly and envision, for example, an effective dimensioning pressure of 0.2 MPa. Specific tubes made of composites can readily meet this requirement.

In this third embodiment, the pipeline may differ from the pipelines described in the preceding embodiments in that it comprises a second pipe 3 made of composite. The ends of the adjacent second pipes 3, according to this last embodiment, are thus connected by a joint cover 203 made of flexible composite, for example Triplex (registered trademark), the ends 204a of which overlap and are adhesively bonded to the external surface of the ends of the adjacent second pipes 3.

The composite consists for example of a fiber-reinforced polymer resin, for example a polyester or epoxy resin reinforced with glass or carbon fibers, which are optionally woven. Furthermore, the composite may be composed so as to exhibit mechanical properties verifying the criterion: Re>E.α.ΔT.

Triplex is a material comprising three layers, namely two external layers of glass fiber fabrics and an intermediate layer of thin metal sheet. Triplex is sold particularly by Hutchinson.

The other identical characteristics of the pipeline bear the same references as in the preceding embodiments. The general configuration of the various elements and the use of the pipeline remain unchanged in the present embodiment.

The use of second pipes 3 made of composite allows a significant reduction in the cost of manufacturing the pipelines.

Although the invention has been described in relation to a number of specific embodiments, it goes without saying that it is in no way restricted thereto and that it comprises all the technical equivalents of the means described together with combinations thereof if these come within the scope of the invention.

TABLE 1
Example of the dimensioning of a sub-sea pipeline C at a depth of 35 m

| | Pᵢₙₜ | Pₑₓₜ | P_{eff} | D | | | | Rₑ | Rₚₑ | e_{Min} | |
|---|---|---|---|---|---|---|---|---|---|---|---|
| | (MPa) | (MPa) | (MPa) | (mm) | A | C % | S | (MPa) | (MPa) | (mm) | |
| First pipe 1 | 1.6 | 0.1 | 1.5 | 800 | 0.9 | 0.00 | 1.5 | 670 | 446.67 | 1.49 | C Cold |
| Second pipe 3 | 1.6 | 0.1 | 1.5 | 886 | 0.9 | 0.00 | 1.11 | 470 | 423 | 1.75 | A At |
| | | | | | | | | | | | 20° C. |
| Protective casing 6 | 0.1 | 0.45 | −0.35 | 1118 | 0.9 | 0.33 | 2 | 215 | 107.5 | 2.63 | A At |
| | | | | | | | | | | | 20° C. |

1. Thermally insulated pipeline (T, C) comprising from the inside to the outside:
a first sealed pipe (1),
a first thermal insulation layer (2),
a second sealed pipe (3),
a second thermal insulation layer (4) made of insulating material, and
a ballast (5) made of material with a density above that of sea water,
characterized in that said first thermal insulation layer (2) is made of insulating material, said pipeline additionally comprising a sealed, impact-resistant protective casing (6) outside said ballast (5).

2. Pipeline according to claim 1, characterized in that at least one element from the group consisting of the first pipe (1), the second pipe (3) and the protective casing (6) has mechanical characteristics such that:
Re>E.α.ΔT
where E is the modulus of elasticity of the constituent material,
α is the coefficient of thermal expansion of the constituent material,
ΔT is the difference between the service temperature of said element and the ambient temperature,
and Re is the yield strength of the material at the service temperature of said element.

3. Pipeline according to claim 1 , characterized in that at least one of said pipes (1, 3) is provided with at least one system (30) for compensating thermal contraction.

4. Pipeline according to claim 3, characterized in that said system (30) for compensating thermal contraction takes the form of a sleeve (31) comprising at least one radial corrugation (32).

5. Pipeline according to claim 1, characterized in that at least one element from the group consisting of the first pipe (1), the second pipe (3) and the protective casing (6) is anchored at its ends to fixed abutments (B), which take up the thermal stresses to which said element is subjected.

6. Pipeline according to claim 1, characterized in that at least one of the thermal insulation layers (2, 4) is made of a material having a thermal conductivity of below 20.10⁻³W.m⁻¹.K⁻¹ at ambient temperature, preferably below 16.10⁻³W.m⁻¹.K⁻¹ at −160° C.

7. Pipeline according to claim 6, characterized in that at least one of the thermal insulation layers (2, 4) is made of aerogel-type porous nanomaterial.

8. Pipeline according to claim 1, characterized in that at least one of said sealed pipes (1, 3) consists of an alloy with a high nickel content.

9. Pipeline according to claim 1, characterized in that the second sealed pipe (3) is made of a polymer resin-based composite.

10. Pipeline according to claim 1, characterized in that said ballast (5) consists of a material capable of being cast in a liquid, pulverulent or granular form into the cylindrical volume contained between the second insulation layer (4) and the protective casing (6).

11. Pipeline according to claim 10, characterized in that said ballast (5) comprises concrete.

12. Pipeline according to claim 11, characterized in that said ballast (5) comprises at least one hollow duct (12) provided in the latter.

13. Pipeline according to claim 1, characterized in that at least one of the thermal insulation layers (2, 4) is present in a pulverulent or granular form allowing it to be cast into the volume intended to receive it.

14. Pipeline according to claim 13, characterized in that said thermal insulation layer (2, 4) in a pulverulent or granular form comprises at least one section closed off at its two longitudinal ends by blocking devices (8) made of insulating material.

15. Pipeline according to claim 13 , characterized in that said thermal insulation layer (2, 4) in a pulverulent or granular form comprises at least one spacer bar (14) made of insulating material, which is arranged parallel to said pipeline and has a thickness substantially equal to that of said thermal insulation layer (2, 4).

16. Pipeline according to claim 1, characterized in that it consists of prefabricated sections (T) which can be connected end to end.

17. Pipeline according to claim 16, characterized in that the sections (T) have at least one stepped end (E), the constituent elements of said sections (T) having a relatively decreasing longitudinal extension in the outwardly radial direction.

18. Pipeline according to claim 1, characterized in that a device for detecting leaks is arranged in the longitudinal direction over the whole length of the pipeline (C), between the first pipe (1) and the protective casing (6).

19. Use of a pipeline (C) according to claim 1 for transporting a low-temperature fluid.

20. Use according to claim 19, in which an inerting gas is circulated through at least one of the thermal insulation layers (2, 4).

21. Sea terminal for the transportation of liquefied gas, characterized in that it comprises a loading and unloading station (P) connected to a land installation (I) by at least one pipeline according to claim 1.
